(19) United States
(12) Patent Application Publication
(10) Pub. No.: US 2009/0028016 A1
(43) Pub. Date: Jan. 29, 2009

(54) OPTICAL DISK DRIVE

(75) Inventor: Kaname Hayasaka, Iruma-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC CORPORATION, Tokyo (JP)

(21) Appl. No.: 12/170,364

(22) Filed: Jul. 9, 2008

(30) Foreign Application Priority Data
Jul. 27, 2007 (JP) 2007-196340

(51) Int. Cl. G11B 20/10

(52) U.S. Cl. 369/47.15

(57) ABSTRACT

An optical disk drive that performs logical overwrite and that enables reconstitution of arbitrary data acquired before logical overwrite. When data are written over a recorded area, the data are alternately recorded in an unrecorded user data area, thereby performing logical overwrite processing. Every time logical overwrite is performed, a system controller cumulatively prepares a correlation list consisting of an old physical address achieved before logical overwrite, an alternately-recorded new physical address, and a data length acquired before logical overwrite and records the thus-prepared list into an optical disk. When logical overwrite is performed a number of times, arbitrary data achieved before logical overwrite are reproduced by sequential reference to the old physical address of the correlation table.

### PRIORITY INFORMATION

This application claims priority to Japanese Patent Application No. 2007-196340 filed on Jul. 27, 2007, which is incorporated herein by reference in its entirety.

### BACKGROUND OF THE INVENTION

1. Technical Field

The present invention relates to an optical disk drive, and more particularly to an optical disk drive having a logical overwrite function.

2. Related Art

In relation to an optical disk, such as a BD (blu-ray disk), there has been proposed logical overwrite (or pseudo overwrite) for setting a destination of data alternation to an unrecorded area of a user data area rather than to spare areas, by application of a defect management system for a write-once optical disk; namely, a system that alternately records data in spare areas provided along inner and outer radii of an optical disk in the event of occurrence of an error during recording operation and that registers and manages alternation information in a defect list. For instance, when data are written over a BD-R, a processor of an optical disk drive alternately records data in the head of an unrecorded area of the user data area upon receipt of a command for writing data into a recorded area and writes alternation information into the defect list. When data are reproduced, the processor determines, upon receipt of a data read command, whether or not an address from which data are to be read is registered in the list by reference to the defect list. When data are registered, the data are read from an address of a destination of alteration. Logical overwrite is specified by UDF2.6.

In the meantime, reconstitution of original data performed in the event of data having been erroneously overwritten is not particularly specified. A method for recovering a file system in the event of occurrence of an accident and a method for cancelling overwrite processing are described in JP 2006-172528 A. Specifically, descriptions provide that a record area management information area RMA is included in a lead-in area; that record area management data RMD, disk structure definition information DDS, and defect list table DLT are included in RMA; that a DDS update counter and an address of the DLT are included in a DDS; and a reconstitution DLT address (file management information and a DLT address where a DLT determined to have no inconsistencies in a file is recorded) and an effective DLT address (a currently-effective DLT address) are included in the address of the DLT; and that, in such a configuration, logical overwrite processing is canceled by rewriting an effective DLT address on the basis of a reconstituted DLT address. The DLT address is included in a DDS, and hence the DDS is updated.

However, the related art enables only recovery of the DLT achieved at a certain period of time in order to cancel logical overwrite. To put it another way, when a plurality of files are updated or added, processing performed last time is canceled rather than recovery of only a desired file. Although a DLT can be selectively reconstituted, recovery of a specific file to a previous generation is impossible.

### SUMMARY

The present invention provides an apparatus that enables logical overwrite and individual recovery of a logically-overwritten data or file to an arbitrary generation.

To this end, the present invention is directed toward an optical disk drive that, when data are written over a recorded area, performs logical overwrite processing by alternately recording the data in an unrecorded user data area, the drive comprising a preparation unit that, every time logical overwrite is performed, cumulatively prepares a correlation list formed from an old physical address acquired before logical overwrite, an alternately-recorded new physical address, and a data length acquired before logical overwrite; a recording unit that records the correlation list in an optical disk; and a reproduction unit that, when logically-overwritten data are reproduced, performs reproduction by reference to the correlation list.

In an embodiment of the present invention, the reproduction unit reproduces arbitrary data achieved before logical overwrite by sequential reference to the old physical address of the correlation table when logical overwrite is performed a number of times.

The present invention enables logical overwrite processing and reconstitution of arbitrary data acquired before logical overwrite.

The invention will be more clearly comprehended by reference to the embodiment provided below. However, the scope of the invention is not limited to the embodiment.

### BRIEF DESCRIPTION OF THE DRAWINGS

A preferred embodiment of the present invention will be described in detail by reference to the following drawings, wherein:

FIG. 1 is an overall block diagram of an optical disk drive;

FIG. 2 is an explanatory view of a list achieved when logical overwrite operation is performed;

FIG. 3 is an explanatory view of a list achieved when logical overwrite operation is performed a number of times;

FIG. 4 is an explanatory view of a display in a reconstitution mode; and

FIG. 5 is an explanatory view of another list achieved when logical overwrite is performed a number of times.

### DETAILED DESCRIPTION

An embodiment of the present invention will be described by reference to the drawings.

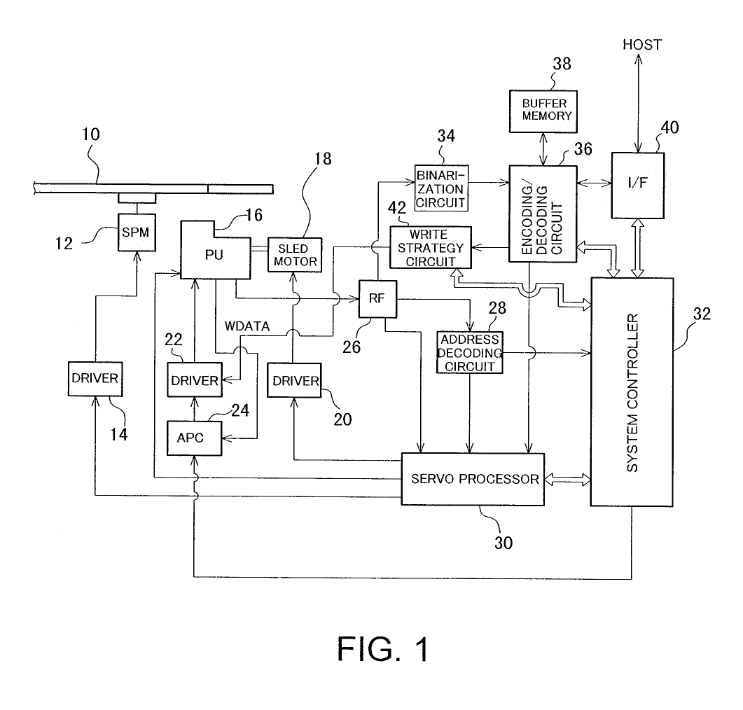

FIG. 1 shows an overall block diagram of an optical disk drive of an embodiment. An optical disk 10, such as a BD, is rotationally driven by means of a spindle motor (SPM) 12. The spindle motor SPM 12 is driven by a driver 14, and the driver 14 is servo-controlled by a servo processor 30 so as to achieve a desired rotational speed.

The optical pickup 16 includes a laser diode (LD) for radiating a laser beam onto the optical disk 10 and a photodetector (PD) that receives light reflected from the optical disk 10 and that converts the thus-received light into an electric signal, and is disposed opposite the optical disk 10. The optical pickup 16 is driven in a radial direction of the optical disk 10 by means of a sled motor 18, and the sled motor 18 is driven by a driver 20. As is the case with the driver 14, the driver 20 is servo-controlled by the servo processor 30. The LD of the optical pickup 16 is driven by a driver 22, and an automatic power control circuit (APC) 24 controls a drive current for the driver 22 in such a way that laser power comes to a desired level. The APC 24 and the driver 22 control amounts of light emission of the LD under a command from a system controller 32. In the drawing, the driver 22 is provided separately from the optical pickup 16, but the driver 22 may also be incorporated into the optical pickup 16 as will be described later.

When data recorded in the optical disk 10 are reproduced, a laser beam of reproducing power is emitted from the LD of the optical pickup 16; resultant reflected light is converted into an electric signal by the PD; and the electric signal is output. A reproduced signal from the optical pickup 16 is fed to an RF circuit 26. The RF circuit 26 generates from the reproduced signal a focus error signal and a tracking error signal and feeds the thus-generated signals to the servo processor 30. In accordance with these error signals, the servo processor 30 servo-controls the optical pickup 16, thereby maintaining the optical pickup 16 in on-focus and on-track states. Moreover, the RF circuit 26 feeds an address signal included in the reproduced signal to an address decoding circuit 28. The address decoding circuit 28 demodulates address data pertaining to the optical disk 10 from the address signal and feeds the thus-demodulated address data to the servo processor 30 and the system controller 32. The RF circuit 26 also feeds a reproduced RF signal to a binarization circuit 34. The binarization circuit 34 binarizes the reproduced signal and feeds the thus-acquired signal to an encoding/decoding circuit 36. The encoding/decoding circuit 36 subjects the binarized signal to demodulation and error correction, to thus acquire reproduced data. The reproduced data are output to a host, such as a personal computer, by way of an interface I/F 40. When the reproduced data are output to the host, the encoding/decoding circuit 36 outputs the reproduced data after temporarily storing the data in buffer memory 38.

When data are recorded in the optical disk 10, data to be recorded from the host are fed to the encoding/decoding circuit 36 by way of the interface I/F 40. The encoding/decoding circuit 36 stores in the buffer memory 38 the data to be recorded; encodes the data to be recorded; and feeds the thus-encoded data as modulated data to a write strategy circuit 42. In accordance with a predetermined recording strategy, the write strategy circuit 42 converts the modulated data into a multipulse (a pulse train), and feeds the multipulse as record data to the driver 22. Since the recording strategy affects recording quality, the strategy is fixed to a certain optimum strategy in normal times. The laser beam whose power is modulated by record data is emitted from the LD of the optical pickup 16, whereupon data are recorded in the optical disk 10. After recording of data, the optical pickup 16 radiates a laser beam of reproducing power, thereby reproducing the record data; and feeds the record data to the RF circuit 26. The RF circuit 26 feeds a reproduced signal to the binarization circuit 34, and the thus-binarized data are fed to the encoding/decoding circuit 36. The encoding/decoding circuit 36 decodes the modulated data, and verifies the thus-decoded data against record data stored in the buffer memory 38. A result of verification is fed to the system controller 32. The system controller 32 determines whether to continually record data in accordance with the result of verification or to perform alternating operation. Recording quality may also be evaluated by decoding modulated data and measuring an error rate of decoded data rather than decoding modulated data and verifying decoded data against the record data stored in the buffer memory 38, thereby performing alternating operation according to recording quality. By means of alternating operation, data are alternately recorded in a spare area located along the inner or outer radius of the optical disk as mentioned previously, and an original address and an address achieved after alternate recording are registered in a defect list as a pair.

In the meantime, when the optical disk 10 is a write-once optical disk, such as a BD-R, the optical disk drive performs logical overwrite processing upon receipt of a write command for specifying a recorded address. During logical overwrite processing, upon receipt of the write command for specifying a recorded address, the system controller 32 alternately records the data into an unrecorded area of a user data area of the optical disk 10; combines, as a set, a physical address achieved before an overwrite (an old physical address), a physical address achieved after alternate recording (a new physical address), and a data length of data achieved before an overwrite; and records the set into a predetermined area of the optical disk 10. The predetermined area is an area in an optical disk assigned as an area that is freely available for a drive designer or a manufacturer. For instance, the predetermined area corresponds to a Drive Specific Information area in each of data frames located within a drive area in a lead-in area of a BD. The Drive Area is provided in four regions at each of two locations; namely, a total of eight regions. Further, one Drive Area is constituted of 32 physical clusters, and recording is carried out while the physical cluster is taken as a unit. The Drive Area itself is not provided such that data are recorded in synchronism with ordinary file recording or alternate processing and is a region that the drive can freely use at original timing. One physical cluster is made up of 32 sectors, each of which has a 2k size. and the sectors are numbered from Data Frame 0 to Data Frame 31. When a new cluster is subjected to recording, the oldest sector of previously-recorded clusters; namely, Data Frame 31, is deleted. Data in the previous clusters are slid from Data Frame 0 to Data Frame 1, and data in Data Frame 1 are slid to Data Frame 2. There is a rule of new data being eventually added solely to Data Frame 0. Of two kilobytes, 48 bytes are assigned to the name of a manufacturer; 48 bytes are assigned to an additional ID; 32 bytes are assigned to a unique serial number; and remaining 1920 bytes are assigned as a region that the drive designer or the manufacturer can freely use. The set that consists of the old physical address, the new physical address, and the data length and that is achieved when logical overwrite is performed is recorded in the free region. The present embodiment can be said to be a technique unique to an apparatus that subjects to recording or reproduction an optical disk having such a region that the drive designer or the manufacturer can freely use.

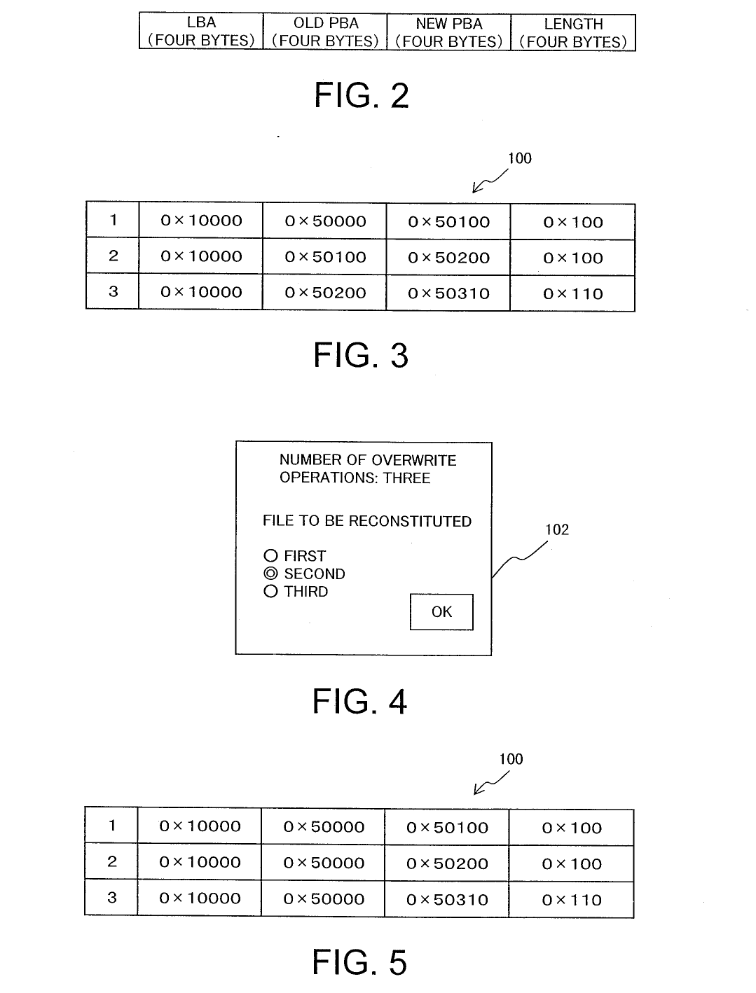

FIG. 2 shows a set recorded in a predetermined area of the optical disk 10. The set is recorded by means of a total of 16 bytes; namely, a logic block address LBA is recorded by means of four bytes; an old physical block address PBA is recorded by means of four bytes; a new physical block address PBA is recorded by means of four bytes; and a data length LENGTH is recorded by means of four bytes. The set consisting of an old physical block address, a new physical block address, and a data length is recorded cumulatively every time logical overwrite is performed. Specifically, when data da in a certain physical block address A are written into data db in a physical block address B by means of logical overwrite and when the data are further written into data dc in a physical block address C through another logical overwrite, a relationship between the physical block address A and the physical block address B and a relationship between the physical block address B and the physical block address C are cumulatively recorded rather than only a relationship between the physical block address A and the physical block address C being registered as a defect list as in the related art. Cumulatively recording relationships every time logical overwrite is performed is intended for enabling reconstitution of data in an arbitrary generation even when logical overwrite is performed a number of times. Mere reproduction of logically-overwritten data does not require cumulative recording of correlations, because only requirement is to ascertain a physical block address of finally-overwritten data. Incidentally, when cumulative recording is performed every time logical overwrite is carried out, the relationship between the physical block address A and the physical block address B and the relationship between the physical block address B and the physical block address C may also be accumulated in internal cache memory and the relationships may be collectively recorded in a predetermined area of the optical disk 10 at specific timing, such as ejection or standby condition rather than a correlation list being recorded directly in a predetermined area of the optical disk 10 at timing of preparation of the correlation list. This recording method enables economization of a limited predetermined area. A philosophy of restoring only a specific file to an old version is not in the related art. In contrast, all pieces of history information are accumulated every time logical overwrite is performed, and the information is finally recorded in a predetermined area of the optical disk 10 as in the present embodiment, whereby only a specific file can be restored to an old version.

In the case of cumulative recording of history information, it is desirable to number respective sets in sequence. For example, a certain set is numbered “1” by means of first logical overwrite; the set is numbered “2” By means of second logical overwrite; and so on. When data are reproduced, a physical block address of the latest data can be ascertained by means of following list numbers in ascending order. Alternatively, presence of a list showing correlations among logical overwritten data may also be distinguished by inserting a text or a code, such as “LOW” (Logical Over Write), into the head of; for instance, Drive Specific Information.

FIG. 3 shows a list 100 prepared when data in a certain logic address are subjected to logical overwrite a total of three times. The list shows that a physical block address 0x50000 of a logic block address 0x10000 is subjected to overwrite processing in the first logical overwrite, to thus record data into a physical block address 0x50100. The original data length is 0x100. The list shows that data are recorded in a physical block address 0x50200 by means of alternate recording during second logical overwrite. An old physical block address is a physical block address 0x50100 where data were actually recorded by means of the first logical overwrite. A data length of the overwritten original data is 0x100. The list shows that data are recorded in a physical block address 0x50310 by means of alternate recording during third logical overwrite. The old block address is a physical block address 0x50200 where data were actually recorded by means of second logical overwrite. The data length of the overwritten original data is 0x110. Moreover, when the list showing correlations is recorded in a predetermined area of the optical disk 10 at predetermined timing after having been accumulated in cache memory, logical overwrite is carried out in sequence of A1→A2→A3 and B1→B2, and hence a correlation list indicates
A1 0x10000, 0x50000, 0x50100, 0x100
A2 0x10000, 0x50100, 0x50200, 0x100
A3 0x10000, 0x50200, 0x50310, 0x110
B1 0x20000, 0x60000, 0x60100, 0x100
B2 0x20000, 0x60000, 0x60200, 0x100.
   When A4 is further logically written over A3, the list is sorted as
A1 0x10000, 0x50000, 0x50100, 0x100
A2 0x10000, 0x50100, 0x50200, 0x100
A3 0x10000, 0x50200, 0x50310, 0x110
A4 0x10000, 0x50310, 0x50420, 0x110
B1 0x20000, 0x60000, 0x60100, 0x100
B2 0x20000, 0x60000, 0x60200, 0x100, and
   the list may also be recorded in a predetermined area of the optical disk 10 (attention should be paid to a change in sequence of A4). When compared with a case where logical overwrite is performed without involvement sorting, the recording method enables an increase in search speed.

As mentioned above, every time logical overwrite is performed, a list is cumulatively prepared and recorded by means of taking an old physical address, a new physical address, and a data length as a set, whereby data or a file in an arbitrary generation can be restored on a per-data or per-file basis. Specifically, for instance, at the time of mere reproduction of data, the latest physical block address 0x50310 is ascertained by sequential reference to sets 1, 2, and 3, whereupon a file or data can be reproduced. However, when the second logically-overwritten data or file is restored by cancellation of the final logical overwrite, the essential requirement is to select sets 1 and 2 from the list and read data by reference to a new physical block address achieved at a point in time when second logical overwrite is completed. Moreover, the data length achieved by means of the second logical overwrite is recorded in the data length for the set 3, and hence the essential requirement is to make a reference to that data length. Specifically, the physical address is 0x50200, and a data length is 0x110.

When the first logically-overwritten data or file is restored by cancellation of the second and third logical overwrite operations, the essential requirement is to select set 1 from the list and read data by reference to a new physical block address achieved at a point in time when the first logical overwrite is completed. Moreover, the data length achieved at the time of first logical overwrite is recorded in the data length for set 2, and hence a reference is made to that data length. Specifically, the physical address is 0x50100, and a data length is 0x100.

When it is desired to cancel all logical overwrite operations and restore the first data or file, the essential requirement is to select the set “1” from the list and make a reference to an old physical block address and a data length.

Detailed processing is as follows. First, there is performed search of a physical cluster in a Drive Area on the optical disk 10 where data were finally recorded. Since data are sequentially recorded from the head in the Drive Area, search of the finally-recorded physical cluster is easy. Next, respective sectors are checked from Data Frame 0 to Data Frame 31 that are the update data in the cluster. Specifically, data pertaining to Drive Specific Information in each of the sectors are first checked, and a check is also made as to whether or not a text “LOW” or a corresponding code is in the head. When the text “LOW” or code is found, data pertaining to the Drive Specific Information are read as an existing correlation list into memory. In the meantime, when the text “LOW” or code is not found, the next sector is checked. The reason for this is that the optical disk 10 is used in another drive or where the area of Drive Specific Information is subjected to any writing. When the text “LOW” or code is not found at all as a result of checking of all finally-recorded physical clusters, another physical cluster recorded prior to the cluster is checked. In this case, Data Frame 0 to Data Frame 30 are common to Data Frame 1 to Data Frame 31 of the finally-recorded cluster, and hence checking of the sectors is not necessary, and checking of only sector Data Frame 31 is required. The physical clusters are sequentially checked as mentioned above, and the clusters will be checked up to the head (the oldest) Drive Area unless the text “LOW” or code is found. When a correlation list is not present, the optical disk 10 is taken as not having a history to which the present technique is applied, and a correlation list is newly prepared. Thus, when an existing or newly-prepared correlation list is subjected to logical overwrite, a change is made to the list. Data in the cache memory are actually recorded in the predetermined area of the optical disk 10 at predetermined timing, such as ejection and a standby condition.

At the time of reconstitution of data that have yet to be logically overwritten, it is desirable to provide, on a display of a host such as a personal computer connected to the optical disk drive, a screen for inquiring the generation of a file or data to be reconstituted from the user. FIG. 4 shows an example screen. When the user commands a reconstitution mode, the system controller 32 makes a reference to a designated list of logical block address; acquires the number of times logical overwrite is performed by reference to a number on the list; and outputs the thus-acquired number of times to the host. On the basis of the received count data, the host provides the number of overwrite operations on the display 102. Moreover, a menu by means of which the user designates the number of an overwrite operation to be reconstituted is displayed. The drawing shows the first, second, and third overwrite operations and also shows that the user has selected the second overwrite operation by actuation of a mouse or cursor. When the user clicks an OK button, the host commands the optical disk drive to cancel the third logical overwrite. Upon receipt of a command for cancelling the third logical overwrite operation, the system controller 32 reconstitutes the file or data from “1” and “2” in the list, by reference to a new physical block address.

In the present embodiment, in contrast with actual overwrite operation, logical overwrite operation includes reconstituting a file or data of an arbitrary generation by utilization of presence of a file or data that has yet to be overwritten on an optical disk. Security can also be enhanced by making it intentionally impossible to reconstitute a file or data of a specific generation. For instance, when reconstitution is inhibited in connection with the embodiment shown in FIG. 3, a flag showing inhibition of reconstitution is set on all of “1,” “2,” and “3” of the list. When the user commands reconstitution, a reference is sequentially made to the list. However, when the flags is set on the list, data are reproduced only from a new physical address included in the latest list. Disabling reconstitution of only the first logically-overwritten data, or the like, is also possible. In this case, a reconstitution inhibition flag is set on “1” of the list. A determination can also be made on a per-user basis as to whether or not to enable reconstitution. When reconstitution is inhibited without fail, the original data may also be physically destroyed (physically overwritten).

In the present embodiment, a list such as that shown in FIG. 3 is prepared, and the list is recorded in the optical disk 10. However, the pattern of a list is arbitrary. In short, the minimum requirement is that, when a disk is subjected to logical overwrite a plurality of times, an old physical address, a new physical address, and a previous data length of each operation be recorded in an associated manner. It may also be possible to record an old address and a new address as a pair and separately manage a data length achieved before overwrite. It may also be possible to record the original physical address and the latest physical address as a pair and to separately record correlation lists for respective operations. When data are merely reproduced, a file or data are reproduced by reference to a set consisting of the original physical address and the latest physical address. Only when data are reconstituted, a reference is made to the correlation lists of respective operations, and a file or data are reproduced.

FIG. 5 shows another pattern of the list. When first logical overwrite is performed, an old physical address 0x50000, a new physical address 0x50100, and a data length achieved after overwrite are recorded. When second logical overwrite is performed, the original old physical address 0x50000, a new physical address 0x50200, and a data length acquired after overwrite are recorded. When third logical overwrite is performed, the original old physical address 0x50000, a new physical address 0x50200, and a data length acquired after overwrite are recorded. When data are reproduced, a new physical address is acquired from the list of number “3”, and data are reproduced. When the third logical overwrite is canceled, it is better to reproduce data achieved after the second overwrite operation by reference to a list of number “2.” When the second and third overwrite operations are canceled, it is better to reproduce data acquired after the first overwrite operation by reference to a list of number “1.” When all of the first, second, and third overwrite operations are canceled, it is better to make a reference to an old physical address of the list of number “1.” The original data length must be separately recorded.

Since the capacity of the correlation list of the present embodiment is limited to 1920 bytes, there is a possibility of the list exceeding capacity when logical overwrites arise frequently. Accordingly, when the list exceeds capacity, the correlation list must be deleted. When there are files logically overwritten many times, it is better to delete files having older histories or files for which long times have elapsed since final logical overwrite. Deletion may also be performed automatically or interactively by way of an application program. Moreover, in order to prevent bloating of the correlation list in advance, it may also be possible to designate files to be added to the correlation list or not to be added to the same by means of an application program or to automatically distinguish files to be added from those not to be added by means of an extension of a file.

What is claimed is:

1. An optical disk drive that, when data are written over a recorded area, performs logical overwrite processing by alternately recording the data in an unrecorded user data area, the drive comprising:
a preparation unit that, every time logical overwrite is performed, cumulatively prepares a correlation list formed from an old physical address acquired before logical overwrite, an alternately-recorded new physical address, and a data length acquired before logical overwrite;
a recording unit that records the correlation list in an optical disk; and
a reproduction unit that, when logically-overwritten data are reproduced, performs reproduction by reference to the correlation list.

2. The optical disk drive according to claim 1, wherein, when logical overwrite is performed a number of times, the reproduction unit reproduces arbitrary data acquired before logical overwrite by sequential reference to an old physical address of the correlation table.

3. The optical disk drive according to claim 1, wherein the recording unit subjects the optical disk to recording at timing when the preparation unit prepares the correlation list.

4. The optical disk drive according to claim 1, wherein the recording unit subjects the optical disk to recording at predetermined timing including a time of ejection of the optical disk.

5. The optical disk drive according to claim 1, wherein the recording unit records the correlation list and adds to the predetermined area specific information showing that the correlation list is recorded.

6. The optical disk drive according to claim 1, further comprising:
a deletion unit that selectively deletes old list in time sequence such that the correlation list does not exceed predetermined capacity.

7. The optical disk drive according to claim 1, further comprising:
a unit that indicates, on a display of a host connected to the optical disk drive, the number of logical overwrite operations and a menu for specifying logical overwrite to be restored among the plurality of logical overwrite operations.
